(19) United States
(12) Patent Application Publication
(10) Pub. No.: US 2008/0285473 A1
(43) Pub. Date: Nov. 20, 2008

(54) ACCESS AND BACKHAUL FRAME INTERLACING FROM TIME DIVISION DUPLEX WIRELESS COMMUNICATION SYSTEM

(75) Inventors: David T. Chen, Palatine, IL (US); Philip J. Fleming, Glen Ellyn, IL (US); Fan Wang, Chicago, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/747,939

(22) Filed: May 14, 2007

(51) Int. Cl. H04J 3/14

(52) U.S. Cl. 370/252; 370/280

(57) ABSTRACT

A method, base station, and wireless communications system for interlacing Access and Backhaul frames in a Time Division Duplex wireless communication system. The method includes monitoring Access traffic and Backhaul traffic (604). Access traffic characteristics, Backhaul traffic characteristics, and corresponding frame control overhead information are determined in response to the monitoring (606). The method also includes determining an amount of time required to deliver a substantially equal amount of bearer Access traffic and Backhaul traffic (608). A frame interlacing ration is determined (608) in response to determining the amount of time required to deliver a substantially equal amount of bearer Access traffic and Backhaul traffic. A set of Access frames (302) and a set of Backhaul frames (304) are interlaced on a frequency band using the determined frame interlacing ratio.

### FIELD OF THE INVENTION

The present invention generally relates to the field of wireless communications, and more particularly relates to scheduling access and backhaul traffic in a time division duplexing system.

### BACKGROUND OF THE INVENTION

Wireless communication systems have evolved greatly over the past few years. Current wireless communication systems are capable of transmitting and receiving broadband content such as web browsing, streaming video and audio. One communication scheme used in today's wireless communication systems is time division duplex (“TDD”). TDD allows for the transmission and reception of data from a base station to subscriber units on a single frequency band. In TDD systems, such as a WiMAX (Worldwide Interoperability for Microwave Access) system, there is Access traffic and Backhaul traffic. Access traffic is wireless communication traffic generated to/from a base station and wireless subscriber units such as cellular phones, notebook computers, and the like. Backhaul traffic is generated to/from fixed network components, such as base stations, for transmitting data to the greater serving network.

Wireless microwave radio has emerged as a crucial backhaul technology for connecting base stations to the network. This is especially true in emerging markets, where there is little fixed transmission infrastructure to be used for wireline backhaul, and for wireless operators not affiliated with an incumbent wireline operator. In typical TDD systems, base stations need two separate radios for receiving and transmitting Access traffic and Backhaul traffic if a wireless backhaul is provisioned instead of a wireline backhaul. This can be a costly expense for network operators especially for a prospective operator trying to build and establish a large customer base. One example of high costs associated with maintaining Backhaul connections can be seen in systems that multiplex the traffic from several radio sectors at a site. These systems use a much higher speed radio at the site to backhaul the traffic to yet another site. This typically requires additional multiplexing hardware, high bandwidth radios, and a separate frequency band.

Therefore a need exists to overcome the problems with the prior art as discussed above.

### SUMMARY OF THE INVENTION

Briefly, in accordance with the present invention, disclosed are a method, base station, and wireless communications device for interlacing Access and Backhaul frames in a Time Division Duplex wireless communication system. The method includes monitoring Access traffic and Backhaul traffic. Access traffic characteristics, Backhaul traffic characteristics, and corresponding frame control overhead information are determined in response to the monitoring. The method also includes determining an amount of time required to deliver a substantially equal amount of bearer Access traffic and Backhaul traffic. A frame interlacing ratio is determined in response to determining the amount of time required to deliver a substantially equal amount of bearer Access traffic and Backhaul traffic. A set of Access frames and a set of Backhaul frames are interlaced on a frequency band using the determined frame interlacing ratio.

In another embodiment, a base station in a Time Division Duplex wireless communication system adapted to interlace Access and Backhaul frames is disclosed. The base station comprises a memory and a processor that is communicatively coupled to the memory. The base station further includes a network traffic management module that is communicatively coupled to the memory and the processor. The network traffic management module is adapted to monitor Access traffic and Backhaul traffic. Access traffic characteristics, Backhaul traffic characteristics, and corresponding frame control overhead information are determined in response to the monitoring. The network traffic management module is also adapted to determine an amount of time required to deliver a substantially equal amount of bearer Access traffic and Backhaul traffic. A frame interlacing ratio is determined in response to determining the amount of time required to deliver a substantially equal amount of bearer Access traffic and Backhaul traffic. A set of Access frames and a set of Backhaul frames are interlaced on a frequency band using the determined frame interlacing ratio

In yet another embodiment, a wireless communications system adapted to interlace Access and Backhaul frames is disclosed. The wireless communication system comprises a plurality of wireless communication devices. A plurality of base stations are communicatively coupled to the plurality of wireless communication devices. At least one base station in the plurality of base stations includes a network traffic management module. The network traffic management module is adapted to monitor Access traffic and Backhaul traffic. Access traffic characteristics, Backhaul traffic characteristics, and corresponding frame control overhead information are determined in response to the monitoring. The network traffic management module is also adapted to determine an amount of time required to deliver a substantially equal amount of bearer Access traffic and Backhaul traffic. A frame interlacing ratio is determined in response to determining the amount of time required to deliver a substantially equal amount of bearer Access traffic and Backhaul traffic. A set of Access frames and a set of Backhaul frames are interlaced on a frequency band using the determined frame interlacing ratio

One advantage of the present invention is that Access and Backhaul traffic can be scheduled on the same TDD channel by interlacing Access and Backhaul frames. This can eliminate the need to license additional bands for wireless backhaul. Moreover, utilizing a portion of the existing, in-band time-orthogonal channels may be more spectrally efficient than using a separate radio in the same band. Additionally, interlacing Access and Backhaul frames on the same channel provides a more simplified integrated Access and Backhaul in-band operation. The present invention takes full advantage of the drastically different link characteristics associated with Access and Backhaul traffic while interlacing each frame type within the same frequency.

Furthermore, by interlacing Access and Backhaul frames complex modifications to schedulers can be avoided. Backhaul service can be provided to an existing wireless cellular system without adding additional network equipment. Another advantage of the present invention is that Backhaul traffic can be dynamically and/or adaptively scheduled in response to changing traffic patterns. Interlacing the Access and Backhaul frames also allows the present invention to use different frame prefixes and control overhead for Access and Backhaul frames.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is block diagram illustrating a wireless communications system, according to an embodiment of the present invention;

FIG. 2 is a timing diagram illustrating examples of interlacing Access and Backhaul frames in a Time Division Duplex system according to an embodiment of the present invention;

FIG. 3 is a block diagram illustrating an Access frame and a Backhaul frame for a Time Division Duplex system according to an embodiment of the present invention;

FIG. 4 is a block diagram illustrating a detailed view of a base station according to an embodiment of the present invention;

FIG. 5 is a block diagram illustrating a wireless communication device, according to an embodiment of the present invention; and

FIG. 6 is an operational flow diagram illustrating a process of interlacing Access and Backhaul frames on the same channel according to an embodiment of the present invention.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

The term wireless communication device is intended to broadly cover many different types of devices that can wirelessly receive signals, and optionally can wirelessly transmit signals, and may also operate in a wireless communication system. For example, and not for any limitation, a wireless communication device can include any one or a combination of the following: a cellular telephone, a mobile phone, a smartphone, a two-way radio, a two-way pager, a wireless messaging device, a wireless data terminal, a laptop/computer, automotive gateway, residential gateway, and the like.

Wireless Communications System

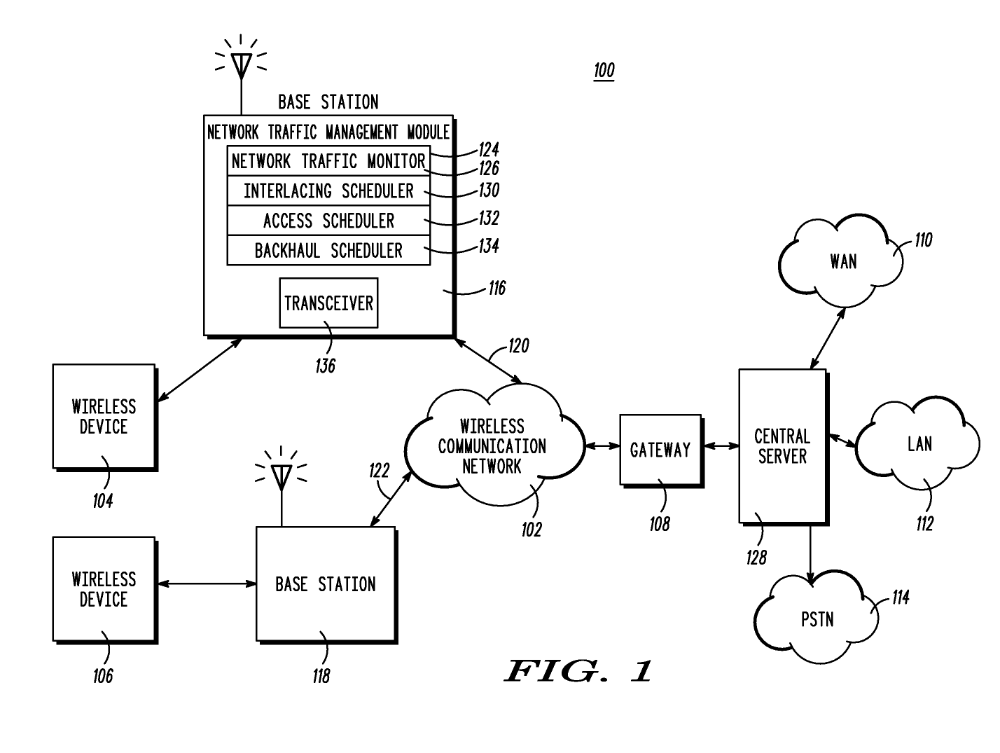

According to an embodiment of the present invention as shown in FIG. 1 a wireless communications system 100 is illustrated. FIG. 1 shows a wireless communication network 102 that connects wireless communication devices 104, 106, to one another, various networks, and the like. The wireless communication network 102, according to the present example, comprises a mobile phone network, a mobile multimedia network, a mobile text messaging device network, a pager network, or the like.

Wireless communications systems can have many kinds of multiple access technologies, such as Code Division Multiple Access (CDMA), Time Division Multiple Access (TDMA), Frequency Division Multiple Access (FDMA), and Orthogonal Frequency Division Multiple Access (OFDMA). Further, the communications standard of the wireless communication network 102 of FIG. 1 comprises Global System for Mobile Communications (GSM), General Packet Radio Service (GPRS), Universal Mobile Telecommunications System (UMTS), High-Speed Downlink and Uplink Packet Access (HSPA), IEEE 802.11 family of standards, IEEE 802.16 family of standards, IEEE 802.20 family of standards, IEEE 802.21 family of standards, or the like. Additionally, the wireless communication network 102 also comprises text messaging standards, for example, Short Message Service (SMS), Enhanced Messaging Service (EMS), Multimedia Messaging Service (MMS), or the like. The wireless communication network 102 also allows for push-to-talk over cellular communications between capable wireless communication devices.

The wireless communication network 102 supports a number of wireless communication devices 104, 106. The support of the wireless network 102 includes support for mobile telephones, smart phones, text messaging devices, handheld computers, pagers, beepers, wireless communication cards, personal computers with wireless communication adapters, or the like. A smart phone is a combination of 1) a pocket PC, handheld PC, palm top PC, or Personal Digital Assistant (PDA), and 2) a mobile telephone. More generally, a smartphone can be a mobile telephone that has additional application processing capabilities.

In one embodiment, the wireless communication network 102 is capable of broadband wireless communications utilizing time division duplexing (“TDD”) as set forth, for example, by the IEEE 802.16e standard. The IEEE 802.16e standard is further described in a system configuration profile determined by the WiMAX forum. The duplexing scheme TDD allows for the transmissions of signals in a downstream and upstream direction using a single frequency band. It should be noted that the present invention is not limited to an 802.16e system for implementing TDD. Other communication systems that the present invention may be applied to include systems utilizing standards such as UMTS LTE (Long Term Evolution), IEEE 802.20, and the like.

Furthermore, the wireless communications system 100 is not limited to a system using only a TDD scheme. For example, TDD may be used only for a portion of the available communication channels in the system 100, while one or more schemes are used for the remaining communication channels. The wireless communication devices 104, 106, in one embodiment, are capable of wirelessly communicating data using the 802.16e standard or any other communication scheme that supports TDD. In another embodiment, the wireless communication devices 104, 106 are capable of wireless communications using other access schemes in addition to TDD.

The wireless communication system 100 also includes one or more information processing systems 128, such as a central server, that maintain and process information for all wireless devices 104, 106 communicating on the wireless network 102. Additionally, each information processing system 128 communicatively couples the wireless communication devices 104, 106 to a wide area network 110, a local area network 112, and a public switched telephone network 114 through the wireless communication network 102 via a gateway 108. Each of these networks has the capability of sending data, such as a multimedia text message, to the wireless devices 104, 106.

The wireless communications system 100 also includes a group of base stations 116, 118. In one embodiment, the base stations 116, 118, are connected to the wireless communication network 102 via a backhaul connection 120, 122. Each base station includes a network traffic management module 124 for providing wireless backhaul that may reduce operator startup costs while avoiding some of the drawbacks present in the prior art approaches. Generally expressed, the base stations 116, 118 (or other wireless network equipment such as an access point, wideband base station, WLAN/WiMAX station, Radio Access Network, or the like) provides a wireless communication device 104, 106 (or other network component) access to a backhaul network via in-band wireless signaling. In other words, the network traffic module 124 interlaces Access traffic frames and Backhaul traffic frames on the same channel thereby eliminating the need for two separate radios and channels for Access traffic and Backhaul traffic.

As discussed above Access traffic is wireless communication traffic generated to/from wireless subscriber units such as cellular phones, notebooks, and the like. Backhaul traffic refers to “getting data to the network backbone” or core network. Interlacing the Access traffic frames and the Backhaul traffic frames in the same frequency bands can eliminate the need to license additional bands for wireless backhaul. Moreover, utilizing a time portion of the existing frequency channels for backhaul traffic can be more spectrally efficient than using a separate radio for backhaul traffic in the same frequency band.

In one embodiment, the network traffic management module 124 includes a network traffic monitor 126. The network traffic monitor 126 monitors the Access traffic and the Backhaul traffic received by one or more transceivers 136 for determining when and how to interlace Access and Backhaul frames. In other words, based on the monitored traffic patterns, the network traffic monitor 126 determines the interlacing ratio between Access traffic and Backhaul traffic. Some of the parameters monitored by the network traffic monitor 126 include Frame Control Header (“FCH”), Downlink Channel Descriptors (“DCD”), Uplink Channel Descriptors (“UCD”), Channel Quality Information (“CQI”), Ranging channel and the like. Access traffic typically has higher control overhead and lower spectral efficiency to accommodate mobiles in low radio quality locations. On the other hand, backhaul traffic typically has lower control overhead and significantly higher spectral efficiency because the backhaul channel typically has a point-to-point clear Line-of-Sight (LOS) fixed connection. The network traffic monitor continuously monitors the maximum information bits each access frame can transmit, and the maximum information bits each backhaul frame can transmit in a recurring observation time window. Based on the fluctuation pattern observed, the network traffic monitor 126 determines the interlacing ratio between access and backhaul traffic, as well as related information.

The monitored traffic pattern information is then passed to various schedulers such as an interlacing scheduler 130, an access scheduler 132, and a backhaul scheduler 134. The access scheduler 132 uses parameters such as FCH, DCD, UCD, CQI, ACK/NACK and other related parameters of the monitored Access traffic to schedule downlink (“DL”) and Uplink (“UL”) data bursts in Access frames. The backhaul scheduler 134 uses parameters such as FCH, DCD, UCD, CQI and other related parameters of the monitored Backhaul traffic to multiplex successfully received data bursts from access frames into one aggregated burst. The backhaul scheduler 134 then schedules this aggregated burst for transmission in one or more Backhaul frames. The interlacing scheduler 130 schedules the interlacing frequency of the Access frames and Backhaul frames created by the access and backhaul schedulers 132, 134 adaptively and dynamically according to traffic pattern changes. In one embodiment, the interlacing scheduler 130 interlaces Access and Backhaul frames when the summation of Access and Backhaul traffic is less than the available air capacity in a sector maintained by the base station 116, 118.

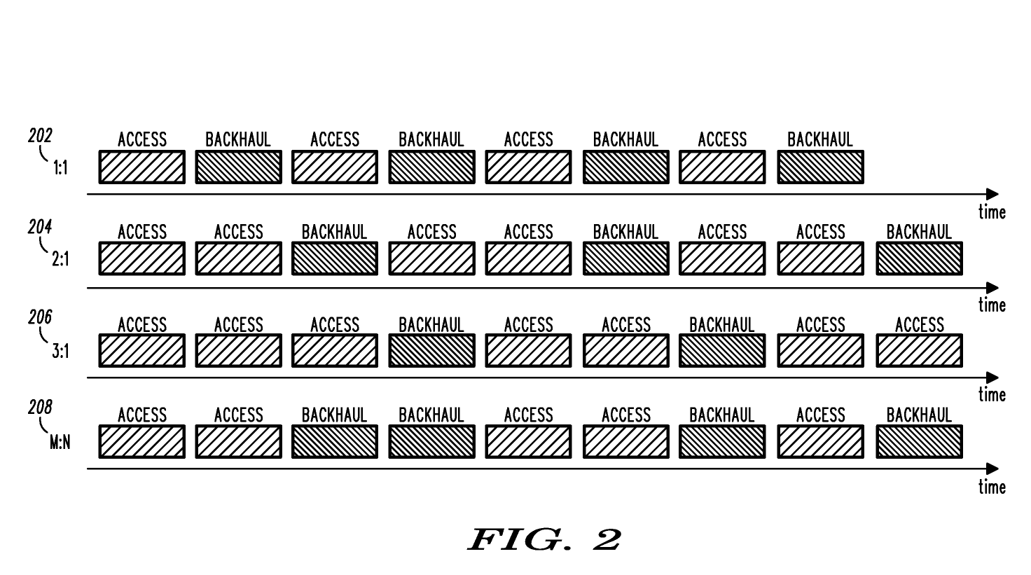

FIG. 2 shows a few examples of how Access frames and Backhaul can be interlaced and sent out on the same channel according to an embodiment of the present invention. FIG. 2 shows a first interleaving scheme 202 where the interlacing ratio is 1 to 1. In other words, Access traffic is scheduled in odd frames and Backhaul traffic is scheduled in even frames, or vice versa. FIG. 2 also shows a second interlacing scheme 204 that has a 2 to 1 ratio. In this interlacing scheme two Access frames are scheduled and then one Backhaul frame is scheduled. A third interlacing scheme 206 has a 3 to 1 ratio where three Access frames are scheduled and the one Backhaul frame scheduled. A fourth interlacing scheme 208 is also shown having an M to N ratio. One advantage of the present invention is that current Access schedulers and Backhaul schedulers do not have to be modified to implement the present invention.

Based on the information on Access and Backhaul traffic fluctuation patterns monitored by the network traffic monitor, the Interlacing Scheduler 130 determines the interlacing ratio between access and backhaul traffic in each recurring observation time window. In some windows, the ratio may be 1 to 1. In some other windows, the ratio may be 2 to 1, 3 to 1, or M to N. One advantage of the present invention is that Interlacing Scheduler 130 can dynamically change the interlacing ratio in each recurring time window to adapt to the ever changing traffic need.

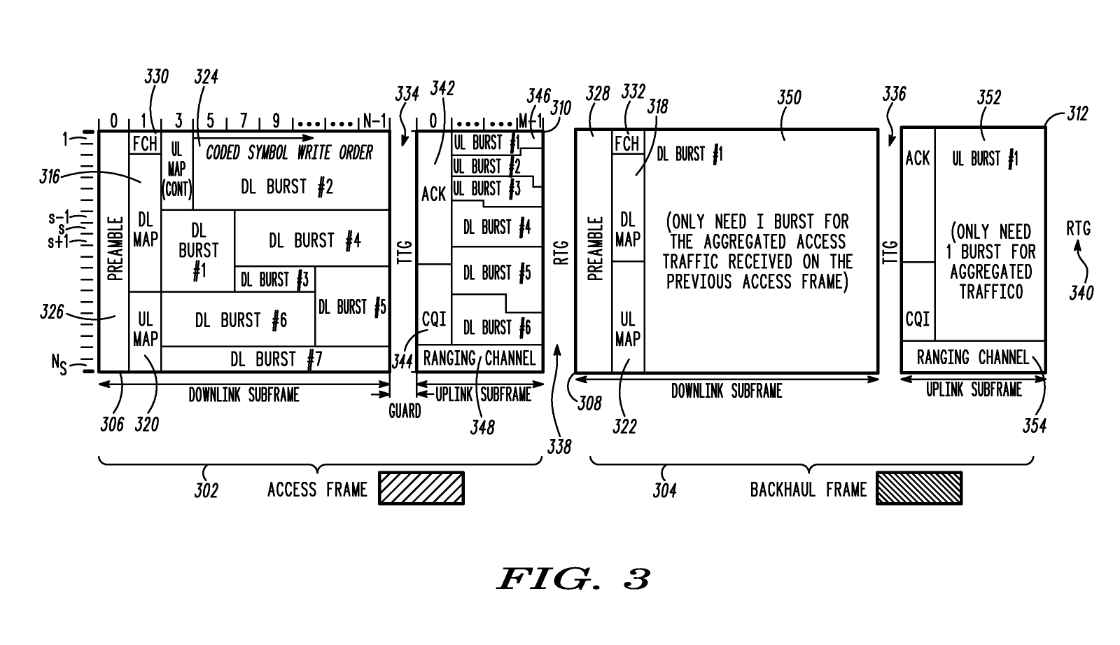

FIG. 3 shows an example of an Access frame 302 and a Backhaul frame 304. FIG. 3 shows an Access frame 302 and a Backhaul frame for an 802.16e system where a downlink subframe 306, 308 and an uplink subframe 310, 312 have been segmented. The downlink subframe 306, 308 of the Access and Backhaul frames 302, 304 has two dimensions, which are time (symbols, e.g. 23 symbols) and frequencies (tones). It should be noted that the present invention is not limited to these symbols or a fixed symbol time.

A particular wireless communication device can be assigned to a symbol and/or tones within the time-frequency space of the downlink subframe 306, 308. For example, the base station 116, 118 transmits a downlink map 316, 318 to each of its wireless devices 104, 106. The wireless devices 104, 106 use the downlink map to identify which symbol(s) it has been assigned for receiving data from the base station 116, 118. In other embodiments, the downlink map is used to identify the symbols and tones that the device has been assigned to. In other words, the downlink map identifies when a base station 116, 118 is going to transmit to that particular device. The base station 116, 118 also transmits an uplink map 320, 322 via a downlink to the wireless devices 104, 106. The downlink, in one embodiment, has 30 sub-channels (uplink can have 35 sub-channels), which are groups of tones. The uplink map 320, 322 identifies which sub-channel and slots a particular device is assigned and the modulation and coding scheme to be used for that sub-channel. In one embodiment, a slot is N tones by M symbols and multiple slots can be allocated to a single burst. This is true for both the uplink and downlink maps.

The downlink subframe 306 of the Access frame 302 also includes a plurality of downlink bursts such as DL Burst 324. Each DL burst 324 is associated with a single wireless device 104, 106. The downlink subframes 306, 308 also include a preamble 326, 328 and a frame control header (“FCH”) 330, 332. Each of the Access and Backhaul frames 302, 304 also include a transmit turn guard (“TTG”) portion 334, 336, and a receive turn guard (“RTG”) portion 338, 340. The transmit turn guard 334, 336 is a time period where the wireless device 104, 106 is transitioning from a transmitting mode to a receiving mode. In other words, the wireless device 104, 106 stops transmitting so that it can receive data from the base station 116, 118. The receive turn guard is a time period where the wireless device 104, 106 is transitioning from a receiving mode to a transmitting mode.

The uplink subframe 310 of the Access frame 302 includes acknowledgement information 342, CQI information 344, and UL bursts such as UL burst 346. Each UL burst 346 is associated with a single wireless communication device. As can be seen from FIG. 3, the Access frame can include a plurality of DL bursts 324 each associated with a different wireless device and a plurality of uplink bursts 346 each associated with a different wireless communication device. The uplink subframe of the Access frame 302 also includes a ranging channel 348, which allows wireless devices 104, 106 to synchronize with the base station 116, 118.

For example, as a wireless communication device 104, 106 enters a cell it listens for a downlink communication. In one embodiment, a ranging channel allows the base station 116, 118 to determine the timing difference between the wireless communication devices 104, 106 and the base station 116, 118. As discussed above, in one embodiment, the downlink communication includes a preamble 320 and basic control information (FCH 330), which allows a wireless communication device to determine downlink timing (with an error related to propagation time) and understand other basic aspects of the wireless communication system 100 such as location of uplink ranging.

Once the downlink communication is observed, the wireless communication devices 104, 106 can access the TDD ranging channel 348. A base station 116, 118 can determine a timing delay of a wireless device based on information received from the device on the ranging channel. The base station 116, 118 can then signal the device 104, 106 using a forward link to either advance or retard its timing so that the device 104, 106 is synchronized with other devices 104, 106 in the system 100.

In one embodiment, the downlink subframe 308 of the Backhaul frame 304 includes a single data burst 350, which corresponds to the aggregated Access traffic received from the previous Access frame 302. The uplink subframe 312, in one embodiment, includes a single uplink burst 352 that is associated with the aggregated Access traffic received from the previous Access frame 302. It should be noted that the backhaul frame can include more than one data burst in both the downlink and uplink portion if desired. The uplink frame 312 of the Backhaul frame 304 also includes a ranging channel 354 discussed above.

Returning back to FIG. 1, the interlacing of Access and Backhaul frames by the network traffic management module 124 allows for both traffic types to share the assigned frequency bands. This can eliminate the need to license additional bands for wireless backhaul. Moreover, utilizing a time portion of the existing frequency channels for backhaul traffic can be more spectrally efficient than using a separate radio for backhaul traffic in the same frequency band. Additionally, interlacing Access and Backhaul frames on the same frequency channel provides a more simplified integrated Access and Backhaul in-band operation. The network traffic management module 124 can take full advantage of the drastically different link characteristics associated with Access and Backhaul traffic while interlacing each frame type on the same frequency.

Furthermore, by interlacing Access and Backhaul frames, complex modifications to schedulers can be avoided. Backhaul service can be provided to an existing wireless cellular system without adding additional network equipment. Another advantage of the present invention is that Backhaul traffic can be dynamically and/or adaptively scheduled in response to changing traffic patterns. Interlacing the Access and Backhaul frames also allows the network traffic management module 124 to use different frame prefixes and control overhead for each traffic type.

Base Station

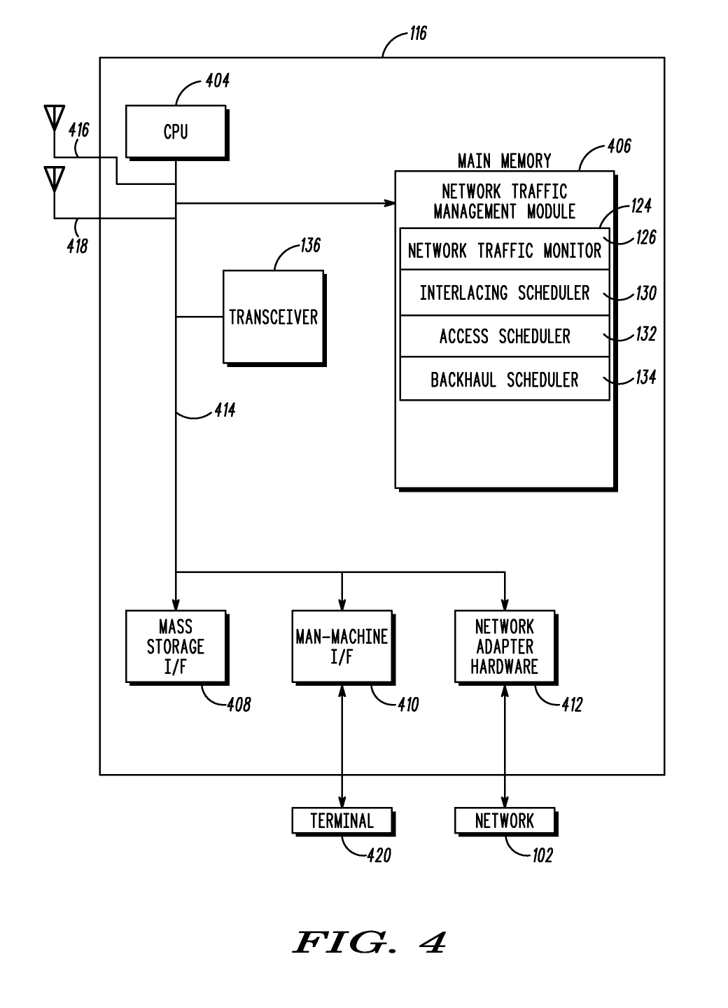

FIG. 4 is a block diagram illustrating a more detailed view of the base station 116, 118 according to an embodiment of the present invention. The following discussion is also applicable to an information processing system such as a site controller (not shown) that controls the base station 116, 118. A site controller (not shown) can reside within its respective base station 116, 118 or can reside outside of its respective base station 116, 118. The base station 116, 118 includes a processor 404 that is connected to a main memory 406 (e.g., volatile memory), one or more transceivers 136, non-volatile memory 408, a man-machine interface (“MMI”) 410, and network adapter hardware 412. One or more antennas 416, 418 are also communicatively coupled to the base station 116, 118. A system bus 414 interconnects these system components. The main memory 406 includes the network traffic management module 124 discussed above. The network traffic management module 124 includes the network traffic monitor 126, the interlacing scheduler 130, the Access scheduler 132, and the Backhaul scheduler 134. These components have been discussed in greater detail above.

The man-machine interface 410 allows for an administrator, repair crew, or the like to couple a terminal 420 to the base station 116, 118. The network adapter hardware 412 is used to provide an interface to the network 102. For example, the network adapter 416, in one embodiment, can provide various connections such as an Ethernet connection between the base station 116, 118 and the wireless communications network 102. An embodiment of the present invention can be adapted to work with any data communications connections including present day analog and/or digital techniques or via a future networking mechanism.

Wireless Communication Device

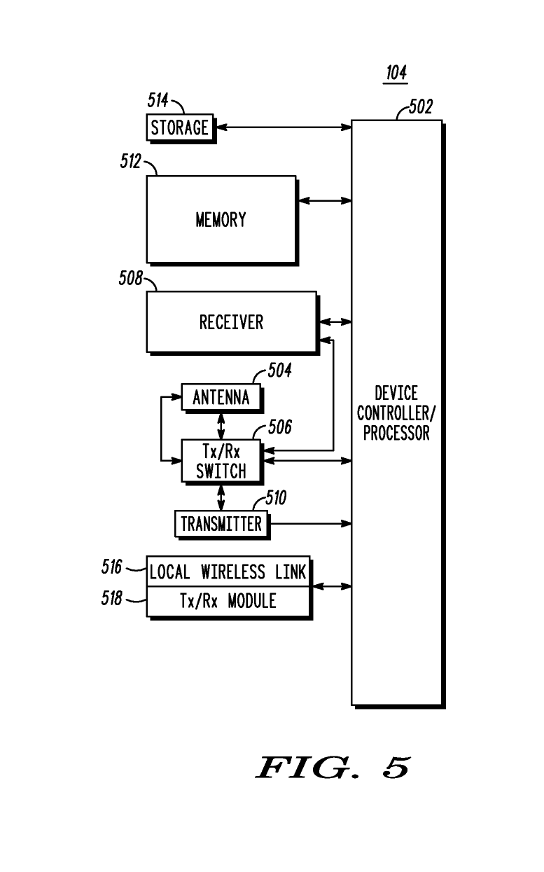

FIG. 5 is a block diagram illustrating a more detailed view of the wireless communication device 104. It should be noted that other wireless communication devices such as wireless communication air interface cards (not shown) are also compatible with the present invention. FIG. 5 illustrates only one example of a wireless communication device type. It is assumed that the reader is familiar with wireless communication devices. To simplify the present description, only that portion of a wireless communication device that is relevant to the present invention is discussed.

In one embodiment, the wireless communication device 104 is capable of transmitting and receiving wireless information on the same frequency such as in an 802.16e system using TDD. The wireless communication device 104 operates under the control of a device controller/processor 502, that controls the sending and receiving of wireless communication signals. In receive mode, the device controller 502 electrically couples an antenna 504 through a transmit/receive switch 506 to a receiver 508. The receiver 508 decodes the received signals and provides those decoded signals to the device controller 502.

In transmit mode, the device controller 502 electrically couples the antenna 504, through the transmit/receive switch 506, to a transmitter 510. The device controller 502 operates the transmitter and receiver according to instructions stored in the memory 512. These instructions include, for example, a neighbor cell measurement-scheduling algorithm.

The wireless communication device 104 also includes non-volatile storage memory 514 for storing, for example, an application waiting to be executed (not shown) on the wireless communication device 104. The wireless communication device 104, in this example, also includes an optional local wireless link 516 that allows the wireless communication device 104 to directly communicate with another wireless device without using a wireless network (not shown). The optional local wireless link 516, for example, is provided by Bluetooth, Infrared Data Access (IrDA) technologies, or the like. The optional local wireless link 516 also includes a local wireless link transmit/receive module 518 that allows the wireless device 104 to directly communicate with another wireless communication device.

Process of Interlacing Access and Backhaul Frames on the Same Channel

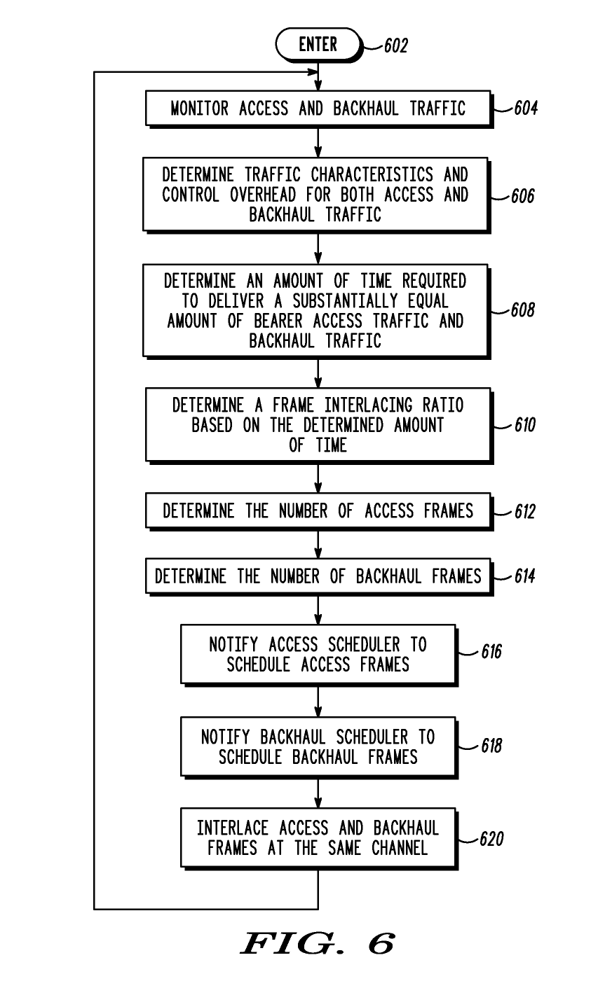

FIG. 6 is an operational flow diagram illustrating a process of interlacing Access and Backhaul frames on the same channel according to an embodiment of the present invention. The operational flow diagram of FIG. 6 begins at step 602 and flows directly to step 604. At step 604, the network traffic management module 124 at a base station 116, 118 monitors Access and Backhaul traffic for its respective cell. At step 606, the network traffic management module 124 determines Access traffic and Backhaul traffic characteristics, as well as the radio link quality for both Access and Backhaul traffic through their control channels. For example, the network traffic management module 124 monitors Frame Control Header, Downlink Channel Descriptors, Uplink Channel Descriptors, Channel Quality Information, and the like.

At step 608, the network traffic management module 124 determines an amount of time required to deliver a substantially equal amount of Bearer Access Traffic and Backhaul Traffic. In one embodiment, the determining performed at step 608 excludes signaling traffic exchanged between a base station and a wireless device and signaling traffic between the base station and a wireless communication network At step 610, the network traffic management module 124 calculates the frame interlacing ratio based on the determined amount of time. At steps 612 and 614, the module 124 determines the number of Access frames and Backhaul frames, respectively.

The ratio of Access frames over Backhaul frames should be as close to the interlacing ratio as possible. In one embodiment, priority is given to the access frames. In one embodiment, the interlacing ratio can be recalculated to give preference to the number of Access frames and then the method subsequently determines if the number of Access and Backhaul frames to fit into average throughput balance check criteria. One example of average throughput balance check criteria is if the difference between the moving average of the average throughput between the Access frames and Backhaul frames over an observation window of, for example 100 frames, is less than a given threshold.

At steps 616 and 618, the network traffic management module 124 notifies the Access scheduler 132 to schedule Access frames, and notifies the Backhaul scheduler 134 to schedule Backhaul frames. At step 620, the interlacing scheduler 130 interlaces the scheduled frames created by the Access and Backhaul schedulers 132, 134. The control then flows back to step 604. For example, the interlacing ratio can be dynamically adjusted in response to changing traffic patterns.

Non-Limiting Examples

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method for interlacing Access and Backhaul frames in a Time Division Duplex wireless communication system, the method comprising:
monitoring Access traffic and Backhaul traffic;
in response to the monitoring, determining Access traffic characteristics, Backhaul traffic characteristics, and corresponding frame control overhead information;
determining an amount of time required to deliver a substantially equal amount of bearer Access traffic and Backhaul traffic;
in response to determining the amount of time required to deliver a substantially equal amount of bearer Access traffic and Backhaul traffic, determining a frame interlacing ratio; and
interlacing a set of Access frames and a set of Backhaul frames on a frequency band using the determined frame interlacing ratio.

2. The method of claim 1, wherein the determining an amount of time required to deliver a substantially equal amount of bearer Access traffic and Backhaul traffic excludes signaling traffic exchanged between a base station and a wireless device and signaling traffic between the base station and a wireless communication network.

3. The method of claim 1, wherein the interlacing further comprises:
notifying an Access frame scheduler to schedule the set of Access frames;
notifying a Backhaul frame scheduler to schedule the set of Backhaul frames; and
interlacing the scheduled set of Access frames and the set of Backhaul frames on the same frequency band.

4. The method of claim 1, wherein the set of Access frames and the set of Backhaul frames each comprise a set of Orthogonal Frequency Division Multiplexing frames.

5. The method of claim 1, wherein each frame in the set of Access frames and the Set of Backhaul frames comprises a downlink subframe and an uplink subframe.

6. The method of claim 1, further comprising:
dynamically and adaptively adjusting an interlacing ratio of the set of Access frames and the set of Backhaul frames in response to changing Access traffic patterns and Backhaul traffic patterns.

7. The method of claim 1, wherein the interlacing further comprises:
interlacing the set of Access frames and the set of Backhaul frames with an equal interlacing ratio.

8. The method of claim 1, wherein the interlacing further comprises:
interlacing the set of Access frames and the set of Backhaul frames with an unequal interlacing ratio.

9. A base station, in a Time Division Duplex wireless communication system, adapted to interlace Access and Backhaul frames, the base station comprising:
a memory;
a processor communicatively coupled to the memory; and
a network traffic management module communicatively coupled to the memory and the processor, the network traffic management module adapted to:
monitor Access traffic and Backhaul traffic;
determine Access traffic characteristics, Backhaul traffic characteristics, and corresponding frame control overhead information, in response to the monitoring;
determine an amount of time required to deliver a substantially equal amount of bearer Access traffic and Backhaul traffic;
determine a frame interlacing ratio, in response to determining the amount of time required to deliver a substantially equal amount of bearer Access traffic and Backhaul traffic and
interlace a set of Access frames and a set of Backhaul frames on a frequency band using the determined frame interlacing ratio.

10. The base station of claim 9, wherein the interlacing further comprises:
notifying an Access frame scheduler to schedule the set of Access frames;
notifying a Backhaul frame scheduler to schedule the set of Backhaul frames; and
interlacing the scheduled set of Access frames and the set of Backhaul frames on the same frequency band.

11. The base station of claim 9, wherein the determined amount of time required to deliver a substantially equal amount of bearer Access traffic and Backhaul traffic excludes signaling traffic exchanged between a base station and a wireless device and signaling traffic between the base station and a wireless communication network

12. The base station of claim 9, wherein each frame in the set of Access frames and the Set of Backhaul frames comprises a downlink subframe and an uplink subframe.

13. The base station of claim 9 wherein the network traffic management module is further adapted to
dynamically and adaptively adjust an interlacing ratio of the set of Access frames and the set of Backhaul frames in response to changing Access traffic patterns and Backhaul traffic patterns.

14. The base station of claim 9, wherein the interlacing further comprises:
interlacing the set of Access frames and the set of Backhaul frames with an equal interlacing ratio.

15. The base station of claim 9, wherein the interlacing further comprises:
interlacing the set of Access frames and the set of Backhaul frames with an unequal interlacing ratio.

16. A wireless communications system adapted to interlacing Access and Backhaul frames, the wireless communications system comprising:
a plurality of wireless communication devices;
a plurality of base stations communicatively coupled to the plurality of wireless communication devices, wherein at least one base station in the plurality of base stations includes a network traffic management module, and wherein the network traffic management module is adapted to:
monitor Access traffic and Backhaul traffic;
determine Access traffic characteristics, Backhaul traffic characteristics, and corresponding frame control overhead information, in response to the monitoring;
determine an amount of time required to deliver a substantially equal amount of bearer Access traffic and Backhaul traffic;
determine a frame interlacing ratio, in response to determining the amount of time required to deliver a substantially equal amount of bearer Access traffic and Backhaul traffic and
interlace a set of Access frames and a set of Backhaul frames on a frequency band using the determined frame interlacing ratio.

17. The wireless communications system of claim 16, wherein the interlacing further comprises:
notifying an Access frame scheduler to schedule the set of Access frames;
notifying a Backhaul frame scheduler to schedule the set of Backhaul frames; and
interlacing the scheduled set of Access frames and the set of Backhaul frames on the same frequency band.

18. The wireless communications system of claim 16 wherein the network traffic management module is further adapted to
dynamically and adaptively adjust an interlacing ratio of the set of Access frames and the set of Backhaul frames in response to changing Access traffic patterns and Backhaul traffic patterns.

19. The wireless communications system of claim 16, wherein the interlacing further comprises:
interlacing the set of Access frames and the set of Backhaul frames with an equal interlacing ratio.

20. The wireless communications system of claim 16, wherein the interlacing further comprises:
interlacing the set of Access frames and the set of Backhaul frames with an unequal interlacing ratio.
